(19) United States
(12) Patent Application Publication
(10) Pub. No.: US 2016/0300432 A1
(43) Pub. Date: Oct. 13, 2016

(54) SYSTEM AND METHOD FOR ON-LINE MULTI-PLAYER INTERACTIVE WAGERING

(71) Applicant: iPro, Inc., Incline Village, NV (US)

(72) Inventors: Shanmugapriyan DEVARAJ, Portland, OR (US); David ORTIZ, Newcastle, WA (US); Shanmugam CHINNASAMY, Bellevue, WA (US); Robert MELENDRES, Incline Village, NV (US)

(21) Appl. No.: 14/684,184

(22) Filed: Apr. 10, 2015

(51) Int. Cl. G07F 17/32

(52) U.S. Cl. CPC G07F 17/3211; G07F 17/3288; G07F 17/3225

(57) ABSTRACT

Systems and methods for on-line multi-player interactive wagering. In accordance with a first method embodiment of the present invention, a computer-implemented method includes selecting an event as a subject of a wager, accepting, from more than one player, a position on a micro event of said event, comparing each of said positions to an outcome of said micro event and awarding or subtracting points to an account of each of said more than one player according to said comparing. The accepting, comparing and awarding are repeated for at least two different micro events of said event. The computer-implemented method further includes distributing winning earnings to an account of said more than one player based on a comparison on points accumulated in all accounts of said one or more players.

### RELATED APPLICATIONS

This application is related to co-pending, commonly owned U.S. patent application Ser. No. __/___,___, attorney docket IPRO-0001-01.01US, filed Apr. 10, 2015, entitled “Method and System for Seamless Transitions between Game Types for Portable Computer Systems” to Devaraj et al., and is hereby incorporated by reference herein in its entirety.

This application is related to co-pending, commonly owned U.S. patent application Ser. No. __/___,___, attorney docket IPRO-0002-01.01US, filed Apr. 10, 2015, entitled “System and Method for Accepting and Creating Electronic Wagers” to Ortiz et al., and is hereby incorporated by reference herein in its entirety.

This application is related to co-pending, commonly owned U.S. patent application No. __/___,___, attorney docket IPRO-0003-01.01US, filed Apr. 10, 2015, entitled “System and Method for On-line Wagering on Real Time Events” to Ortiz et al., and is hereby incorporated by reference herein in its entirety.

This application is related to co-pending, commonly owned U.S. patent application Ser. No. __/___,___, attorney docket IPRO-0004-01.01US, filed Apr. 10, 2015, entitled “System and Method for On-line Fantasy Wagering” to Ortiz et al., and is hereby incorporated by reference herein in its entirety.

This application is related to co-pending, commonly owned U.S. patent application Ser. No. __/___,___, attorney docket IPRO-0006-01.01US, filed Apr. 10, 2015, entitled “Graphical User Interface for On-Line Gaming” to Ortiz et al., and is hereby incorporated by reference herein in its entirety.

U.S. Pat. No. 8,790,176, entitled “System and Method for Real Time Interactive Entertainment” to Hopf and Ortiz, is hereby included by reference in its entirety.

### FIELD OF INVENTION

Embodiments of the present invention relate to the field of electronic applications for mobile computer systems. More specifically, embodiments of the present invention relate to systems and methods for on-line multi-player interactive wagering.

### BACKGROUND

Legal wagering on sporting events, or other events, is generally a solitary affair, in which a gambler places a wager against the “house.” For example, a casino establishes the subject of a wager and sets the odds of that wager. Even though multiple parties may accept the wager, each wager is made against the impersonal house.

Many people find the competition of betting against other people desirable. Further, many gamblers would like to offer and/or participate in wagers beyond the scope, e.g., at different odds and/or on different subjects, of a casino's rather limited offerings.

### SUMMARY OF THE INVENTION

Therefore, what is needed are systems and methods for on-line multi-player interactive wagering. What is additionally needed are systems and methods for on-line multi-player interactive wagering that enable a player to select numerous details of positions on micro events of sporting or other events. A need also exists for systems and methods for on-line multi-player interactive wagering that utilize effective and intuitive graphical user interfaces. Further, a need exists for systems and methods for on-line multi-player interactive wagering that are compatible and complementary with existing systems and methods of on-line and/or mobile gaming. Embodiments of the present invention provide these advantages.

In accordance with a first method embodiment of the present invention, a computer-implemented method includes selecting an event as a subject of a wager, accepting, from more than one player, a position on a micro event of said event, comparing each of said positions to an outcome of said micro event and awarding or subtracting points to an account of each of said more than one player according to said comparing.

In accordance with another embodiment of the present invention, an article of manufacture including a computer readable medium having instructions stored thereon that, responsive to execution by an electronic system, cause the electronic system to perform operations. The operations include selecting an event as a subject of a wager, accepting, from more than one player, a position on a micro event of the event, comparing each of the positions to an outcome of the micro event and awarding or subtracting points to an account of each of the more than one player according to the comparing. The accepting, comparing and awarding are repeated for at least two different micro events of the event. The operations further include distributing winning earnings to an account of the more than one player based on a comparison on points accumulated in all accounts of the one or more players.

In accordance with a further embodiment of the present invention, an electronic system includes one or more processors coupled to a bus, a memory coupled to the one or more processors, wherein the memory comprises a gaming application, a position determining system coupled to the bus operable to determine a geolocation of the electronic system and a graphical user interface coupled to the bus. The electronic system is configured to select an event as a subject of a wager, accept, from more than one player, a position on a micro event of the event, compare each of the positions to an outcome of the micro event, and award or subtracting points to an account of each of the more than one player according to the comparing. The electronic system is configured to repeat the operations of accepting, comparing, and awarding for at least two different micro events of the event. The electronic system is further configured to distribute winning earnings to an account of the more than one player based on a comparison on points accumulated in all accounts of the one or more players.

In accordance with an embodiment of the present invention, a computer-implemented method includes first placing of a first wager. The outcome of the first wager is settled in a virtual currency. The computer-implemented also includes second placing of a second wager. The outcome of the second wager is settled in real currency. The first and second wagers are independent of one another and the first and second placing occurs within the same application. The second wager may be made against the house.

### BRIEF DESCRPTION OF THE DRAWINGS

The accompanying drawings, which are incorporated in and form a part of this specification, illustrate embodiments of the invention and, together with the description, serve to explain the principles of the invention. Unless otherwise noted, the drawings are not drawn to scale.

FIG. 1 illustrates an exemplary block diagram of an exemplary electronic system, which may be used as a platform to implement embodiments of the present invention.

FIG. 2 illustrates an exemplary graphical user interface for multi-player interactive game creation, in accordance with embodiments of the present invention.

FIG. 3A illustrates an exemplary graphical user interface for micro event wagering, in accordance with embodiments of the present invention.

FIG. 3B illustrates an alternative exemplary graphical user interface (GUI) for micro event wagering, in accordance with embodiments of the present invention.

FIG. 4A illustrates an exemplary graphical user interface for selecting details of a micro event, in accordance with embodiments of the present invention.

FIG. 4B illustrates an alternative exemplary graphical user interface (GUI) for selecting details of a micro event, in accordance with embodiments of the present invention.

FIG. 5 illustrates an exemplary graphical user interface for placing a wager on a micro event, in accordance with embodiments of the present invention.

FIG. 6 illustrates a computer-implemented method, in accordance with embodiments of the present invention.

FIG. 7 illustrates a computer-implemented method, in accordance with embodiments of the present invention.

### DETAILED DESCRIPTION

Reference will now be made in detail to various embodiments of the present invention, examples of which are illustrated in the accompanying drawings. While the invention will be described in conjunction with these embodiments, it is understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the invention, numerous specific details are set forth in order to provide a thorough understanding of the invention. However, it will be recognized by one of ordinary skill in the art that the invention may be practiced without these specific details. In other instances, well known methods, procedures, components, and circuits have not been described in detail as not to unnecessarily obscure aspects of the invention.

### NOTATION AND NOMENCLATURE

Some portions of the detailed descriptions which follow (e.g., methods 600 and 700) are presented in terms of procedures, steps, logic blocks, processing, and other symbolic representations of operations on data bits that may be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “accepting” or “selecting” or “determining” or “displaying” or “computing” or “sending” or “receiving” or “reducing” or “detecting” or “setting” or “accessing” or “placing” or “testing” or “forming” or “mounting” or “removing” or “ceasing” or “stopping” or “coating” or “processing” or “performing” or “generating” or “adjusting” or “creating” or “executing” or “continuing” or “indexing” or “translating” or “calculating” or “measuring” or “gathering” or “running” or the like, refer to the action and processes of, or under the control of, a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The terms “micro event” and “sub-event” are used to refer to or to describe an activity within a larger “event,” the outcome of which may be subject to a wager. The event must be occurring at present or in the future, and the outcome(s) of the event and its micro events must be unknown at the present. For example, a football game may be considered an “event,” while individual plays within the game may be considered “micro events.” Similarly, a baseball game may be considered an “event,” while each pitch, and the resulting outcome, e.g., ball, strike, single, double, triple, home run, sacrifice fly, etc., may be considered a “micro event.” For games with a less defined play structure, e.g., basketball, a fixed duration of game time, e.g., five minutes, may constitute a “micro event.” Embodiments in accordance with the present invention are well suited to wagers based on events and micro events within such events.

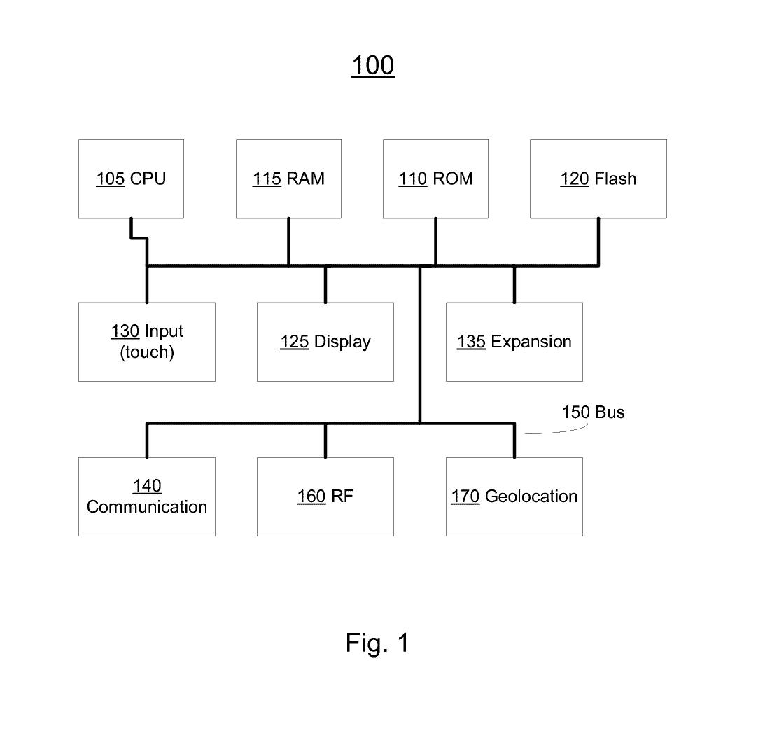

FIG. 1 illustrates an exemplary block diagram of an exemplary electronic system 100, which may be used as a platform to implement embodiments of the present invention. Electronic system 100 may be battery-powered, in some embodiments. Electronic system 100 may be a “server” computer system, in some embodiments. Electronic system 100 may comprise a desktop or generally “fixed location” computer system, in some embodiments. Electronic system 100 may comprise a portable computer system, e.g., a “smart” phone. Electronic system 100 may comprise a “wearable” computer system, e.g., a “smart” watch or an “eye-glass-mounted” computer system. Electronic system 100 includes an address/data bus 150 for communicating information, a central processor 105 functionally coupled with the bus for processing information and instructions. Central processor 105 may comprise a single processor or multiple processors, e.g., a multi-core processor, or multiple separate processors, in some embodiments. Electronic system 100 also includes a volatile memory 115 (e.g., random access memory RAM) coupled with the bus 150 for storing information and instructions for the central processor 105, and a non-volatile memory 110 (e.g., read only memory ROM) coupled with the bus 150 for storing static information and instructions for the processor 105. Electronic system 100 also optionally includes a changeable, non-volatile memory 120 (e.g., flash) for storing information and instructions for the central processor 105 which can be updated after the manufacture of system 100. In some embodiments, only one of ROM 110 or Flash 120 may be present.

Also included in electronic system 100 of FIG. 1 is an optional input device 130. Device 130 can communicate information and command selections to the central processor 100. Input device 130 may be any suitable device for communicating information and/or commands to the electronic system 100. For example, input device 130 may take the form of a keyboard, buttons, a joystick, a track ball, an audio transducer, e.g., a microphone, a touch sensitive digitizer panel, eyeball scanner and/or the like. A touch sensitive digitizer panel may comprise any suitable technology, e.g., capacitive, resistive, optical, acoustic and/or pressure responsive touch panels. Activation of a “touch” sensitive digitizer panel may not require actual touching of the panel 130 or the electronic system 100, in some embodiments. For example, capacitive touch panels may sense proximity of a user's finger or an eyeball scanner may detect a direction of a user's gaze.

The display unit 125 utilized with the electronic system 100 may comprise a liquid crystal display (LCD) device, cathode ray tube (CRT), field emission device (FED, also called flat panel CRT), light emitting diode (LED), plasma display device, electro-luminescent display, electronic paper, electronic ink (e-ink) or other display device suitable for creating graphic images and/or alphanumeric characters recognizable to the user. Display unit 125 may have an associated lighting device, in some embodiments. Display unit 125 may comprise a head-mounted display, in some embodiments.

The touch sensitive digitizer panel 130 is generally associated with the display unit 125. For example, a function of the touch sensitive digitizer panel 130 generally associated with the display unit 125 is to localize a touch input, e.g., from a finger or stylus, to a portion of display unit 125, for example, a single icon image displayed on display unit 125. The touch sensitive digitizer panel may be in front of the actual display device, e.g., in a viewer's optical path, or the touch sensitive digitizer panel may be outside of a viewer's optical path, e.g., behind or to the side of the display device. The touch sensitive digitizer panel 130 may have different planar dimensions in comparison to planar dimensions of a display unit 125. For example, the touch sensitive digitizer panel 130 may be smaller than display unit 125, e.g., the display unit 125 may extend beyond the touch sensitive digitizer panel 130. Similarly, the touch sensitive digitizer panel 130 may be larger than display unit 125, e.g., the touch panel may extend beyond the display unit. The touch sensitive digitizer panel may be integral to a display assembly, or a separate assembly within the electronic system 100. A touch sensitive digitizer panel is not required.

Electronic system 100 also optionally includes an expansion interface 135 coupled with the bus 150. Expansion interface 135 can implement many well known standard expansion interfaces, including without limitation the Secure Digital Card interface, universal serial bus (USB) interface, Compact Flash, Personal Computer (PC) Card interface, CardBus, Peripheral Component Interconnect (PCI) interface, Peripheral Component Interconnect Express(PCI Express), mini-PCI interface, IEEE 1394, Small Computer System Interface (SCSI), Personal Computer Memory Card International Association (PCMCIA) interface, Industry Standard Architecture (ISA) interface, RS-232 interface, and/or the like. In some embodiments of the present invention, expansion interface 135 may comprise signals substantially compliant with the signals of bus 150.

A wide variety of well-known devices may be attached to electronic system 100 via the bus 150 and/or expansion interface 135. Examples of such devices include without limitation rotating magnetic memory devices, flash memory devices, digital cameras, wireless communication modules, digital audio players, and Global Positioning System (GPS) devices.

System 100 also optionally includes a communication port 140. Communication port 140 may be implemented as part of expansion interface 135. When implemented as a separate interface, communication port 140 may typically be used to exchange information with other devices via communication-oriented data transfer protocols. Examples of communication ports include without limitation RS-232 ports, universal asynchronous receiver transmitters (UARTs), USB ports, infrared light transceivers, ethernet ports, IEEE 1394 and synchronous ports.

System 100 optionally includes a radio frequency module 160, which may implement a mobile telephone, a wireless network, e.g., IEEE 802.11 (“Wi-Fi”), Bluetooth, a pager, or a digital data link. Radio frequency module 160 may be interfaced directly to bus 150, via communication port 140, via expansion interface 135, or any suitable interface. Various features of electronic system 100 may be implemented by a combination of hardware and/or software. Electronic system 100 may comprise additional software and/or hardware features (not shown) in some embodiments.

Various modules of system 100 may access computer readable media, and the term is known or understood to include removable media, for example, Secure Digital (“SD”) cards, CD and/or DVD ROMs, diskettes and the like, as well as non-removable or internal media, for example, hard drives, RAM, ROM, flash, and the like.

Electronic system 100 may comprise one or more geolocation determining features 170. For example, electronic system 100 may determine its position by use of a Global Positioning System (GPS), including, for example, the United States Global Position System, the planned European Union Galileo positioning system, India's Indian Regional Navigational Satellite System and/or the Chinese Compass navigation system. Electronic system 100 may also determine its position via a mobile telephone network, for example, identifying, measuring signal strength, and/or triangulation of cell towers. Electronic system 100 may also determine its position from known locations of wireless networks, e.g., WiFi hotspots, from an internet protocol (IP) address, or any other applicable location service(s). Geolocation determining features 170 may comprise dedicated hardware, or may utilize components with one or more other uses.

In accordance with embodiments of the present invention, a gaming application program running on an embodiment of electronic system 100 automatically determines the device's geolocation. While embodiments in accordance with the present invention are generally disclosed using examples of portable computer systems, e.g., “smart phones,” a device's geolocation should be determined even if the electronic system is of a type not generally considered to be portable, e.g., a “desk top” computer system, in accordance with embodiments of the present invention. Based on the geolocation, the device automatically and transparently to the user switches among at least two different types of games. For example, the types of games may include real money gambling, social chips gambling, and/or fantasy gambling. Co-pending, commonly owned U.S. patent application Ser. No. 13/###,###, attorney docket IPRO-0001-01.01US, filed Apr. 10, 2015, entitled “Method and System for Seamless Transitions between Game Types for Portable Computer Systems” to Devaraj et al., incorporated by reference herein in its entirety, discloses further information on determining a legal jurisdiction for wagering.

When the electronic system 100 is located within a jurisdiction that does not allow gambling, only non-gambling types of games, e.g., games for social chips, are made available to the user. When the electronic system 100 is located within a jurisdiction that does allow gambling, then real money gambling is made available to the user. It is appreciated that not all jurisdictions that allow some types of gambling allow all types of gambling. For example, some jurisdictions allow “real money” wagering on “games of skill,” e.g., “fantasy sports,” while prohibiting “real money” wagering on “games of chance,” e.g., singular outcomes. Accordingly, embodiments in accordance with the present invention may provide further granularity as to types of games. For example, based on the laws of a particular jurisdiction, a device may switch among more than one type of real money gambling, e.g., based on a type of wager, in addition to social chips gaming.

In accordance with embodiments of the present invention, players of an on-line gaming application may bet directly against one another, or a third party, e.g., an on-line casino or gaming host. Game play may comprise a series of wagers on micro events within live sporting events or other live events that comprise a series of micro events. For example, many sporting events, e.g., football and baseball games, comprise numerous plays. Other sporting events, e.g., basketball, hockey and soccer games, may be sub-divided into time segments, for example, 5 minutes of game play. Such plays or time segments may be considered micro events.

In accordance with embodiments of the present invention, sporting events characterized as comprising “plays,” e.g., football and/or baseball, may also be sub-divided into time segments representing “micro events, in a similar fashion to those games with a less well-defined play structure.

In addition, in accordance with embodiments of the present invention, football games may support a “drive picks” graphical user interface for use when a player wishes to make the same wager for the duration of a drive, or possession, in a football game. The “drive picks” feature provides a user with a recurring pick window at the end of every drive. The selections made within the “drive picks” graphical interface will generally last until the ball changes possession. The user wagers will be rewarded or credited every time they are successful during sub-divided time segments or “drive picks.” For example, the user may be rewarded multiple times for the same pick.

In accordance with embodiments of the present invention, on-line multi-player interactive wagering is not limited to wagering on sporting events. Rather, any event that may be sub-divided into a series of micro events is suitable for on-line multi-player interactive wagering. For example, wagering may take place on a televised awards show, e.g., the Oscars. Each individual award, e.g., “Best Actor” or “Best Screenplay,” may be considered to be a micro event of the awards show “event.” As another example, an automobile race may be a subject of a wager, while results of each individual lap within the race may be considered to be a micro event of the race “event.”

In accordance with embodiments of the present invention, on-line multi-player interactive wagering comprises a series of wagers, e.g., more than one wager, on micro events of a wager subject. Each wager on a micro event has an outcome, e.g., a player wins or looses, and each outcome results in an award or decrements of points. For example, chips are decremented at the moment a wager is made. A player is awarded points for a successful wager on a micro event, and charged or decremented points for an unsuccessful wager on a micro event. In non-real money games, the points do not have a direct monetary value. Rather, a total number of points, accumulated over a series of micro events, determines an order amongst the bettors. For example, the player with the most points, among two interacting players, wins.

The outcome of all the bets an individual user/player makes contributes to determining a win or a loss. When the user is playing against the casino/host then each wager comprises a two party bet where casino loses or wins based on the outcome of the event. In general, there are three configurations of wagers. In a first configuration, a player bets against the system and a winner is determined from among all players, e.g., which player has the highest score. In a second configuration, a player bets against one or multiple other players, also known as a two-party bet. The two-party bet may be for social chips or for real money. In a third configuration, a player bets against a casino/host, also known as a bet against the house. This third configuration is similar to the first configuration; however, the winner is determined against the casino/host directly, rather than in comparison to the other players.

In contrast to “fantasy” gaming, on-line multi-player interactive wagering generally does not require an entry fee and generally does not payout based on a pool of entry fees. Rather, the overall wager on an event is made directly with a wager host, for example, the wager is a “two-party” bet. The wager host may be a natural person or another type of entity, such as a casino. A wager host may make the same wager on the same event multiple times, e.g., with multiple bettors. However, each wager with each bettor is independent, e.g., it stands on its own.

Many common wagers comprise two parties taking directly opposite positions, e.g., “I bet Kansas City will win” versus “I bet Kansas City will loose.” It is to be appreciated that each “side” of a multi-player interactive wager is not necessarily the “opposite” of the other side, in accordance with embodiments of the present invention. Rather, one player's position on a micro event is independent of all other player's positions on the same micro event. The actual wager is that one player is “better” than another, e.g., will achieve a higher score, across a number of wagers on micro events.

For example, if a first player wagers that the next play in a football game is a run by number 32 up the right hash for 4 to 8 yards, a second player need not wager that the next play in the football game is not a run by number 32 up the right hash for 4 to 8 yards. Such details are known as or referred to as a “position” on the micro event. Rather, the second player may take a position on each micro event that is the same as, somewhat different than, or very different from the first wager. An exemplary “somewhat different” position is that the next play in a football game is a run by number 32 up the right hash for 9 to 35 yards, the difference being only in the yardage gained. If the result of the play is that number 32 ran up the right hash for 10 yards, the second wager will accumulate points, while the first wager will loose points and/or the wager. An exemplary “very different” second position is that the next play in the football game is a pass to number 88 up the left hash for 4 to 8 yards. It is to be appreciated that the exemplary first and second positions are opposing sides of a two-party bet, but the two wagers, while different, are not necessarily “opposite” in terms of the predicted outcome of a micro event.

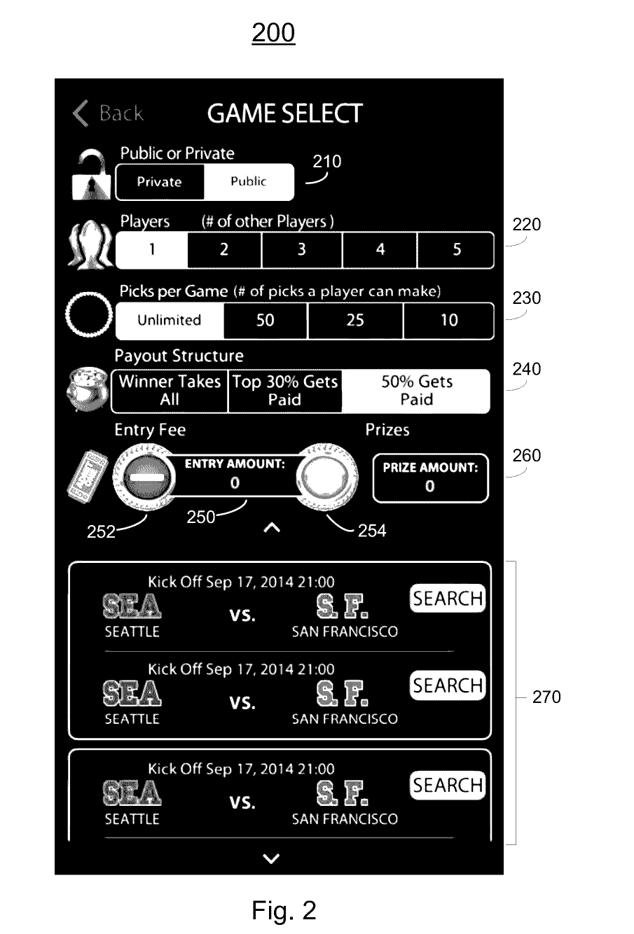

In accordance with embodiments of the present invention, a player may create or initiate a multi-player interactive game. FIG. 2 illustrates an exemplary graphical user interface (GUI) 200 for multi-player interactive game creation, in accordance with embodiments of the present invention. A player may create or initiate a multi-player interactive game using graphical user interface 200.

Multi-player game creation graphical user interface 200 comprises a public/private button set 210. Public/private button set 210 allow a user, e.g., via touch input, to select whether a multi-player game is to be public or private. For example, a public multi-player game is viewable and bet-able by all users of a gaming system, whereas a private Multi-player game is limited to selected users. In the example of FIG. 2, the multi-player game is public.

Graphical user interface 200 also comprises a number of participants button set 220. Number of participants button set 220 enables a Multi-player-game initiator to select a number of participants in a multi-player game. For example, the multi-player-game initiator is willing to challenge from one to five other players. Number of participants button set 220 may scroll or page to display and allow selection of other numbers of participants, in accordance with embodiments of the present invention. In the example of FIG. 2, the creator of the multi-player game is willing to compete with one other player.

Graphical user interface 200 comprises a picks per game button set 230. Picks per game button set 230 enables a multi-player-game initiator to select a number of wagers on micro events in a multi-player game. In the example of FIG. 2, a multi-player game may include wagers on 10, 25, 50, or an unlimited number of micro events. In addition, graphical user interface 200 comprises a payout structure button set 240. Payout structure button set 240 allows a multi-player-game initiator to select from among a set of payout structures to reward achievement in a multi-player game. In the example of FIG. 2, a multi-player-game initiator may select from among a winner takes all payout structure, a payout structure in which players ranking in the top 30% (by points score) receive a payout, and a payout structure in which players ranking in the top 50% (by points score) receive a payout. In the example of FIG. 2, a “top 50%” payout structure has been selected.

Graphical user interface 200 also comprises a multi-player game entry fee selection field 250. Multi-player game entry fee selection field 250 allows a multi-player-game creator to specify an entry fee amount for a multi-player game. For example, an entry fee amount may be increased by touching plus button 254, and decreased by touching minus button 252. Multi-player game entry fee selection field 250 may also operate as a slider, e.g., moving a finger touching within wager amount field 250, toward plus button 254 increases an entry fee amount, while moving a finger toward minus button 252 decreases an entry fee amount.

In addition, graphical user interface 200 comprises a prize amount display field 260. Prize amount display field 260 displays the payout, in currency, of “winning” the multi-player game, based on the entry fee, e.g., as selected in game entry fee selection field 250, the number of participants, e.g., as selected in number of participants button set 220 and a payout structure, e.g., as selected in payout structure button set 240. Graphical user interface 200 further comprises a list 270 of available sporting contests to be included in a multi-player game.

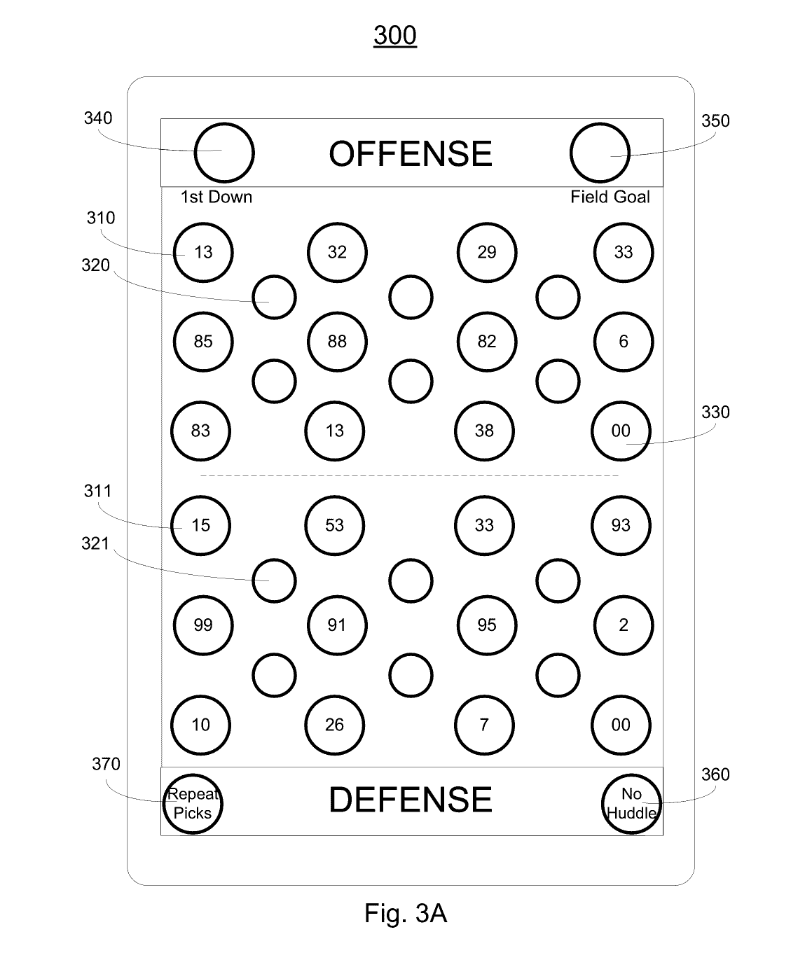

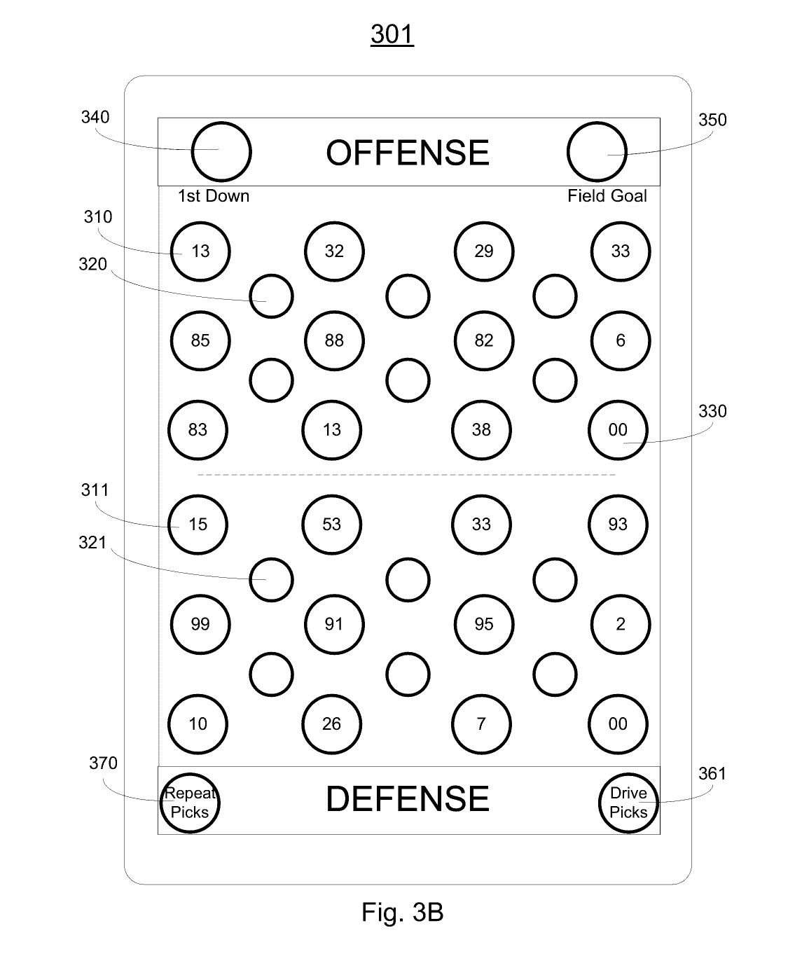

FIG. 3A illustrates an exemplary graphical user interface (GUI) 300 for micro event wagering, in accordance with embodiments of the present invention. In the exemplary embodiment of FIG. 3, the display 300 is configured for wagering on micro events in a football contest. Approximately the top half of display 300 is for initiation of wagers on micro events related to the offensive team, while approximately the bottom half of display 300 is for initiation of wagers on micro events related to the defensive team. Display 300 comprises a plurality of player icons, e.g., player icon 310, comprising a circle outlining a number. Each player icon represents the player with that number that plays at approximately that position. For example, the number 14 may generally correspond to a quarterback, punter, or place kicker. Selecting a player icon, e.g., by touching the icon, will initiate a different display to select specific details of an upcoming play, e.g., a micro event, involving the player indicted by the player icon. Player icons, e.g., player icon 311, are presented for defensive players, as well. An example wager on a defensive micro event may be on which player will tackle a ball carrier, or on which player will intercept a pass.

Display 300 also comprises a plurality of player group icons, e.g., player group icon 320. A player group icon comprises a circle without a number. A player group icon represents a group of four players in closest proximity to the player group icon. For example, player group icon 320 represents players 14, 32, 85 and 88. Selecting a player group icon, e.g., by touching the icon, will initiate a different display to select specific details of an upcoming play, e.g., a micro event, involving one or more of the players indicted by the player group icon. Player group icons, e.g., player group icon 321, are presented for groups of defensive players, as well.

Player icon 330, referring to player “00,” is a special case. Player icon 330 refers to an offensive player other than the players indicated in the other offensive player icons. For example, the numbers in the player icons may refer to the players that start a game. In many sporting contests, including football, players may substitute, sometimes on a play-by-play basis. Accordingly, player icon 330 represents any player, possibly a substitute player, that is not represented by another player icon, e.g., has a different number than a displayed player icon. Player “00” is known as or referred to as a “wild card.”

Display 300 comprises a plurality of team result icons, e.g., 1st down icon 340 and field goal icon 350. Team result icons represent play results, e.g., micro events, which are more generalized than the play results associated with player icons and/or player group icons. For example, 1st down icon 340 represents that the offensive team will achieve a first down by any type of play featuring any player(s). Similarly, field goal icon 350 represents that the offensive team will score a field goal.

Display 300 also comprises a repeat picks icon 370. Repeat picks icon 370 may be used to repeat the wager on a play, e.g., a micro event, that was selected for the immediately preceding play. Display 300 further comprises a no huddle icon 360. No huddle icon 360 initiates a different version of a graphical user interface for use when a duration between plays is decreased, for example, when a multi-player interactive player might not have enough time to select details of a micro event according to graphical user interface 300, e.g., when the offense is playing a “no huddle” style of play.

FIG. 3B illustrates an alternative exemplary graphical user interface (GUI) 301 for micro event wagering, in accordance with embodiments of the present invention. Graphical user interface 301 is substantially similar to graphical user interface 300 (FIG. 3A). The primary difference is that no huddle icon 360 of graphical user interface 300 is replaced with drive picks icon 361. Drive picks icon 361 initiates a different version of a graphical user interface for use when a player wishes to make the same wager for the duration of a drive, or possession, in a football game. The “drive picks” feature provides a user with a recurring pick window at the end of every drive. The selections made within the “drive picks” graphical interface will last until the ball changes possession.

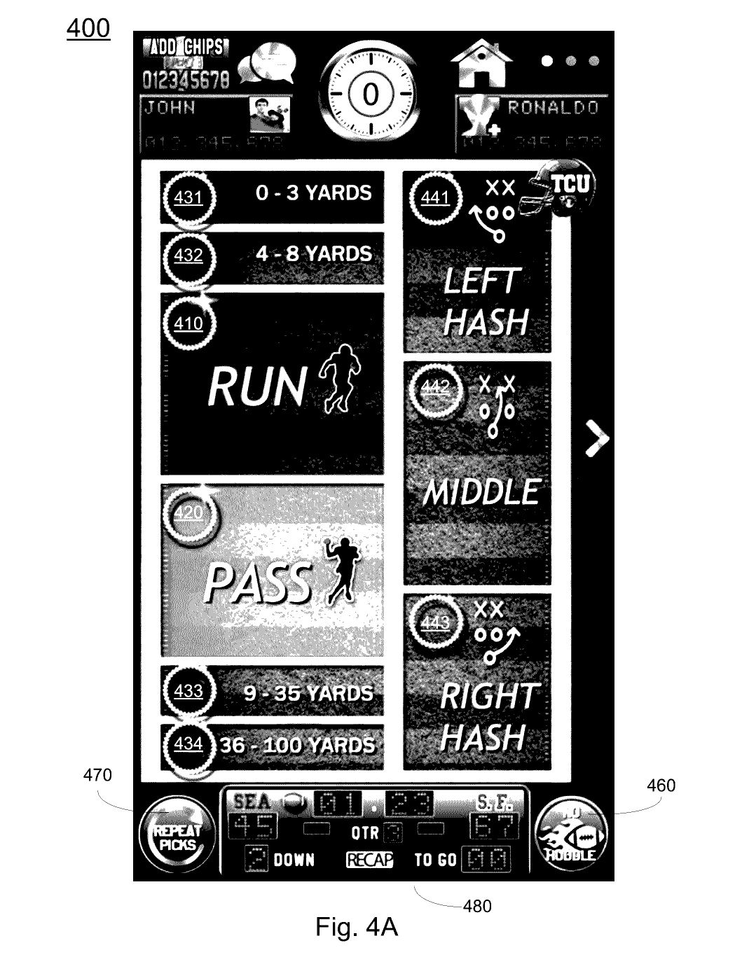

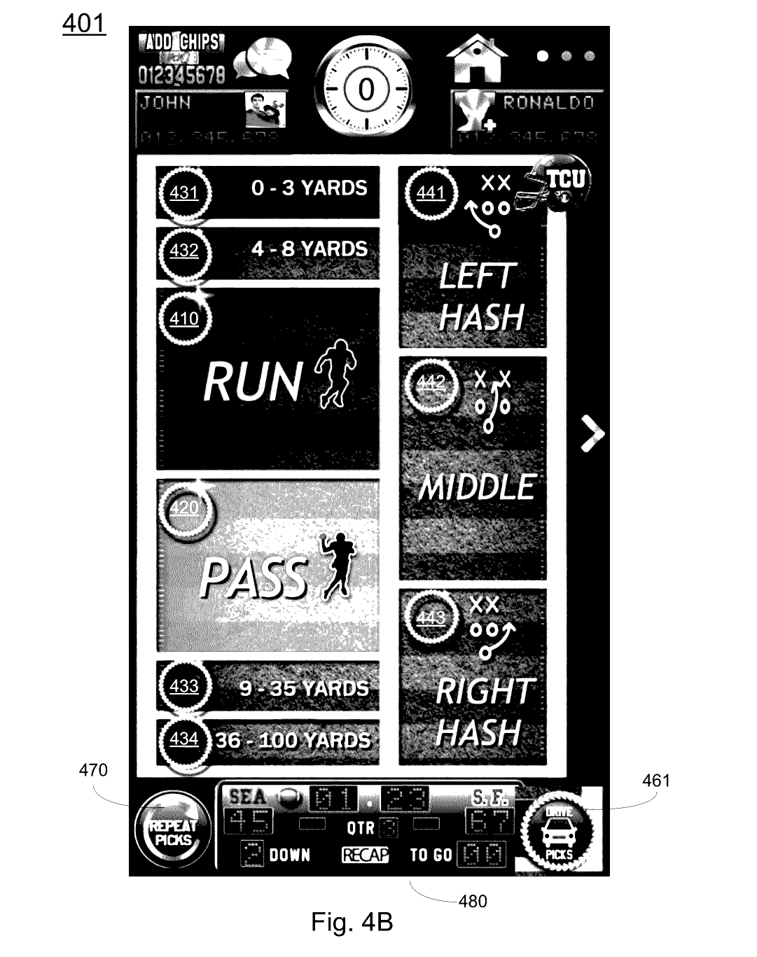

FIG. 4A illustrates an exemplary graphical user interface (GUI) 400 for selecting details of a micro event, in accordance with embodiments of the present invention. Graphical user interface 400 may be presented, for example, responsive to indicating a player icon 310 or a player group icon 320 of FIG. 3. Graphical user interface 400 enables a player to specify a prediction of the results of a next play, e.g., a next micro event. A player may predict a running play via run icon 410, or may predict a passing play via pass icon 420. A player may predict how many yards a play will gain, e.g., via 0-3 yards icon 431, 4-8 yards icon 432, 8-36 yards icon 433 and 36-100 yards icon 434. A player may also predict a direction of an upcoming play, e.g., left hash icon 441, middle icon 442, or right hash icon 443.

Graphical user interface 400 also comprises a repeat picks icon 870, similar to repeat picks icon 370 of FIG. 3, and a no huddle icon 460, similar to no huddle icon 360 of FIG. 3. Graphical user interface 400 further comprises a scoreboard display 480 that presents a variety of information related to the sporting contest.

FIG. 4B illustrates an alternative exemplary graphical user interface (GUI) 401 for selecting details of a micro event, in accordance with embodiments of the present invention. Graphical user interface 401 is substantially similar to graphical user interface 400 (FIG. 4A). The primary difference is that no huddle icon 460 of graphical user interface 300 is replaced with drive picks icon 461. Drive picks icon 461 initiates a different version of a graphical user interface for use when a player wishes to make the same wager for the duration of a drive, or possession, in a football game. The “drive picks” feature provides a user with a recurring pick window at the end of every drive. The selections made within the “drive picks” graphical interface will last until the ball changes possession.

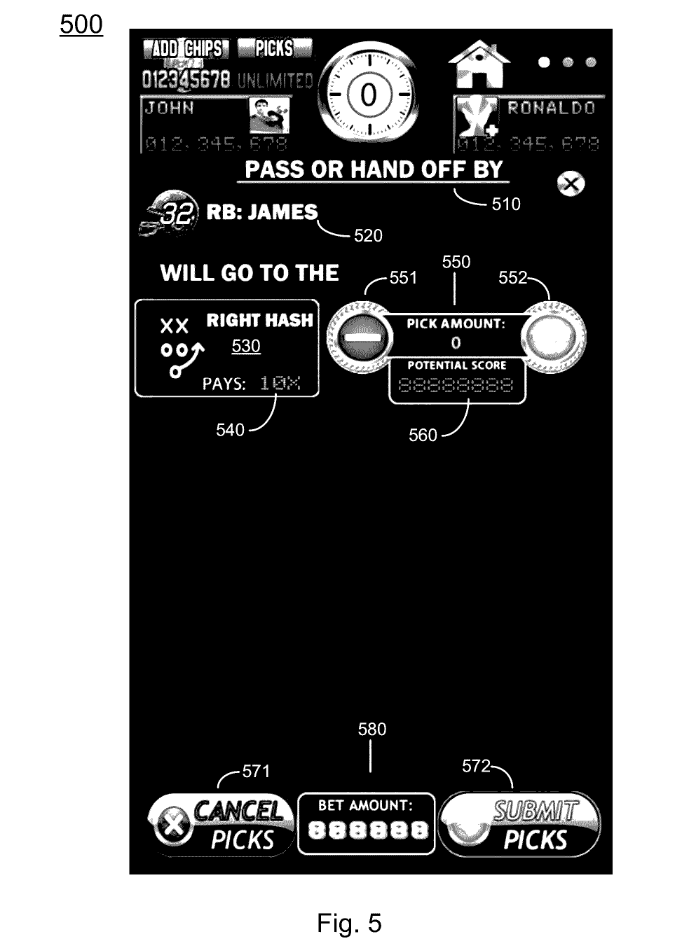

FIG. 5 illustrates an exemplary graphical user interface (GUI) 500 for placing a wager on a micro event, in accordance with embodiments of the present invention. Graphical user interface 500 may be presented, for example, responsive to indicating a variety of predictions for a next play, e.g., micro event, of a sporting contest, for example via graphical user interface 500 of FIG. 5. Graphical user interface 500 comprises a summary play type display 510. In general, summary play type display 510 reflects a play type prediction, for example, a running play or a passing play, identified by selecting run icon 510 or pass icon 520 from graphical user interface 500 of FIG. 5. In the example of FIG. 5, neither run nor pass was predicted. Graphical user interface 500 comprises a summary player display 520. In general, summary player display 520 reflects a player identified by selecting a player icon from graphical user interface 300 of FIG. 3. In the example of FIG. 5, a running back named James wearing number 32 was selected.

Graphical user interface 500 also comprises a play direction summary display 530. In general, summary play direction display 530 reflects a play direction prediction, for example, to the right hash, identified by selecting a play direction icon, e.g., right hash icon 543, from graphical user interface 500 of FIG. 5.

Graphical user interface 500 comprises a likelihood factor display 540. Likelihood factor display 540 displays a multiplication factor of a wager on a micro event. The likelihood factor is inversely correlated with a probability of the particular play, e.g., micro event, happening. In the example of FIG. 5, the micro wager pays ten times the points wagered if the upcoming micro event occurs as predicted by the player. Graphical user interface 500 further comprises a pick amount field 550. Pick amount field 550 allows a user to change an amount of the bet. For example, a pick amount may be increased by touching plus button 552, and decreased by touching minus button 551. Pick amount field 550 may also operate as a slider, e.g., moving a finger touching within pick amount field 550, toward plus button 552 increases a wager amount, while moving a finger toward minus button 551 decreases a pick amount.

In addition, graphical user interface 500 comprises a potential score display 560. Potential score display 560 indicates a number of points that may be won if the upcoming micro event occurs as predicted by the player. Potential score display 560 reflects the pick amount displayed in pick amount field 550 multiplied by the likelihood factor displayed in likelihood factor display 540.

Graphical user interface 500 further comprises a cancel button 571, a submit button 572 and a “bet amount” field 580. Bet amount field 580 displays the total amount, in points, a user will bet, e.g., be at risk, if the bet is created and accepted by the maximum allowed users. Touching or otherwise indicating cancel button 571 terminates the current creation of a bet. Touching or otherwise indicating submit button 572 causes the bet to be created. A subsequent confirmation screen, e.g., “are you sure?”, may be presented, in accordance with embodiments of the present invention. It is appreciated that the bet may be subject to review by a third party, for example, the game provider, which may be an on-line casino, etc., prior to posting to other users for their acceptance.

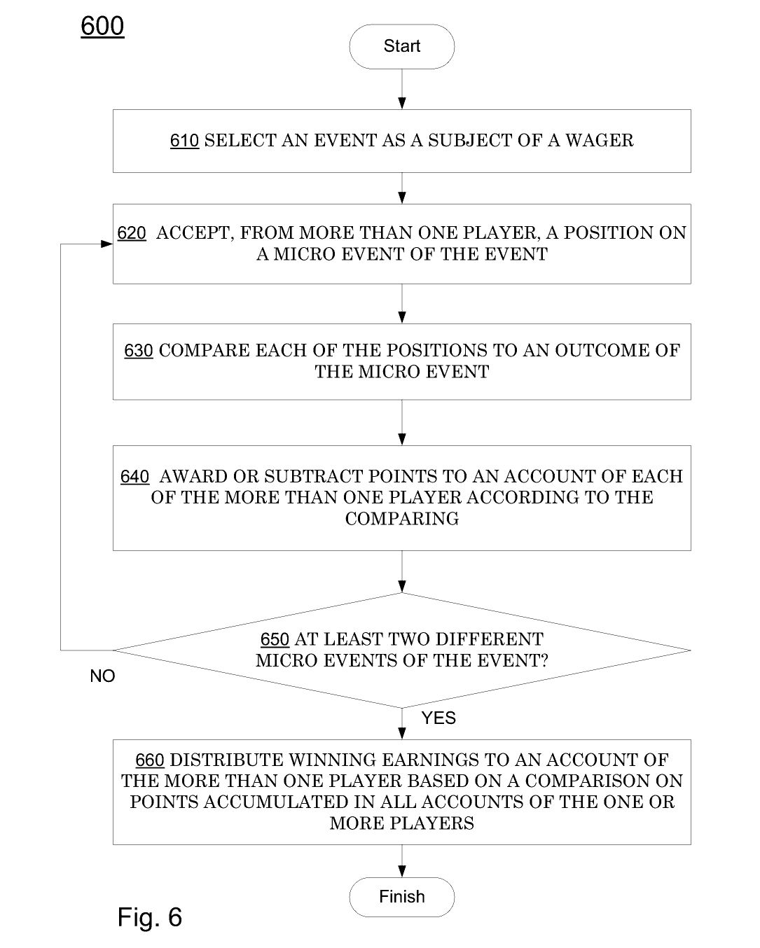

FIG. 6 illustrates a computer-implemented method 600, in accordance with embodiments of the present invention. In 610, an event is selected as a subject of a wager. The event may be a present or future event, including, for example, sporting contests, award shows, and the like. In 620, a position on a micro event of the event is accepted from more than one player. The position may include a number of points, e.g., in virtual currency, or an amount of real currency wagered on the micro event prediction. The number of points or real currency wagered may vary among the players, and may vary among different micro events, e.g., the same player may wager different amounts of points on different micro events. The players may each utilize a different computer system, e.g., each player's smart phone, to enter their respective positions.

In 630, each of the positions is compared to an outcome of the micro event. As previously presented, a position may include a varying amount of detail as to a predicted result of a micro event. Not all details need be specified. For example, a position may specify only that the next play is a running play, without specifying a predicted player, play direction, and/or yardage gained. In 640, points or real money are awarded or subtracted to an account of each of the more than one player according to the comparing. In some embodiments, the points have no direct monetary value. In some embodiments, the points have a direct monetary value, e.g., represent real money. In optional 650, the accepting, comparing and awarding are repeated for at least two different micro events of the event. The repeating may be for a specified number of micro events, e.g., as selected within picks per game button set 230 of FIG. 2.

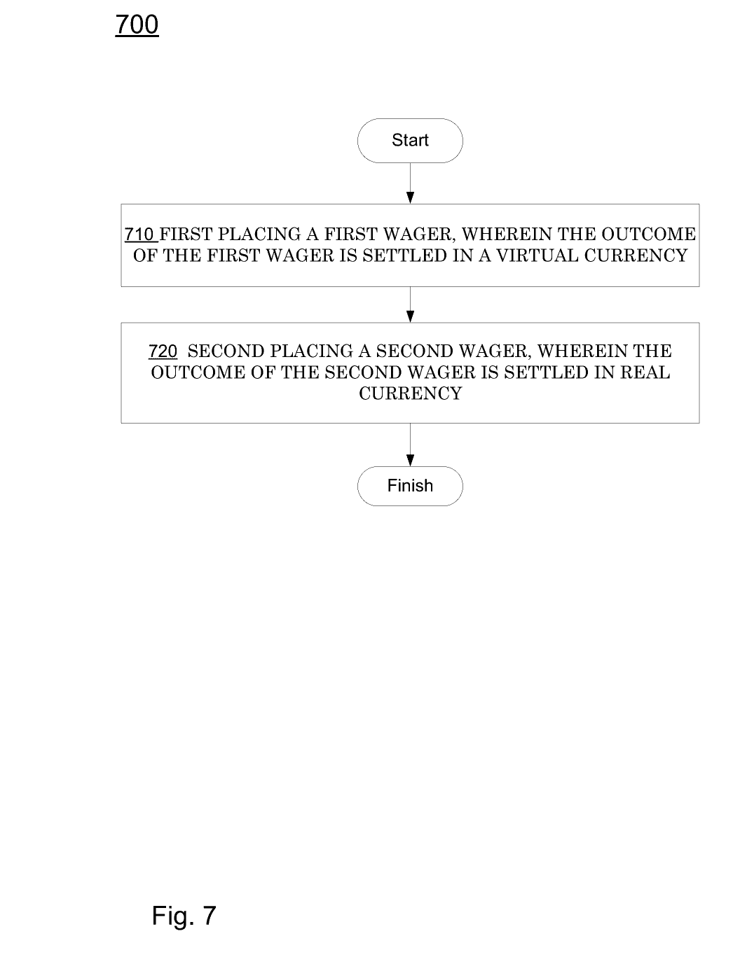

FIG. 7 illustrates a computer-implemented method 700, in accordance with embodiments of the present invention. In 710, a first wager is placed. The outcome of the first wager is settled in a virtual currency. In 720, a second wager is placed. The outcome of the second wager is settled in a real currency. The first and said second wagers are independent of one another, and first and said second wagers are both placed using the same instance of the application. For example, the first and said second wagers are placed using one running copy of one gaming application.

In accordance with embodiments of the present invention, the second wager may be made against the house. For example, the second wager is made against an on-line casino or other “host” of an on-line gambling environment. In accordance with embodiments of the present invention, the first wager may be made against at least one other human player.

In optional 660, winning earnings are distributed to an account of the more than one player based on a comparison on points accumulated in all accounts of the one or more players. For example, the winning earnings are awarded to a player having the most accumulated points. In some embodiments, winning earnings may be awarded to more than one player. The overall wager may include more than one event, in some embodiments. A wager may include back-to-back games, in some embodiments. A wager may include overlapping games, in some embodiments. A wager may include two or more games over a time duration, for example, over the course of several days, e.g., all games played during a particular week, in some embodiments. In such cases, winning earnings are distributed to an account of the more than one player based on a comparison on points accumulated in all accounts of the one or more players for more than one event. In some embodiments, the winning earnings may represent real currency.

Embodiments in accordance with the present invention provide systems and methods for on-line multi-player interactive wagering. In addition, embodiments in accordance with the present invention provide systems and methods for on-line multi-player interactive wagering that enable a player to select numerous details of positions on micro events of a sporting contest. Also, embodiments in accordance with the present invention provide systems and methods for on-line multi-player interactive wagering that utilize effective and intuitive graphical user interfaces. Further, embodiments in accordance with the present invention provide systems and methods for on-line multi-player interactive wagering that are compatible and complementary with existing systems and methods of on-line and/or mobile gaming.

Various embodiments of the invention are thus described. While the present invention has been described in particular embodiments, it should be appreciated that the invention should not be construed as limited by such embodiments, but rather construed according to the below claims.

What is claimed is:

1. A computer-implemented method comprising:
selecting an event as a subject of a wager;
accepting, from more than one player, a position on a micro event of said event;
comparing each of said positions to an outcome of said micro event; and
awarding or subtracting points to an account of each of said more than one player according to said comparing.

2. The computer-implemented method of claim 1 wherein said points have no direct monetary value.

3. The computer-implemented method of claim 1 wherein said points have a direct monetary value.

4. The computer-implemented method of claim 1 further comprising:
repeating said accepting, said comparing and said awarding for at least two different micro events of said event; and
distributing winning earnings to an account of said more than one player based on a comparison on points accumulated in all accounts of said one or more players.

5. The computer-implemented method of claim 4 wherein said winning earnings are awarded to a player having the most accumulated points.

6. The computer-implemented method of claim 4 wherein said winning earnings represent real currency.

7. The computer-implemented method of claim 4 wherein said winning earnings have no direct monetary value.

8. The computer-implemented method of claim 1 wherein a number of said micro events is specified prior to accepting any positions on said micro events.

9. The computer-implemented method of claim 1 wherein said position on said micro event comprises an amount of points wagered on said micro event, and wherein said amount of points may be different for each position.

10. The computer-implemented method of claim 1 wherein input for said accepting is acquired by a different computer system for each of said more than one player.

11. The computer-implemented method of claim 1 wherein said awarding comprises:
awarding winning earnings to an account of said more than one player based on a comparison on points accumulated in all accounts of said one or more players for more than one event.

12. An article of manufacture including a computer readable medium having instructions stored thereon that, responsive to execution by an electronic system, cause the electronic system to perform operations comprising:
selecting an event as a subject of a wager;
accepting, from more than one player, a position on a micro event of said event;
comparing each of said positions to an outcome of said micro event;
awarding or subtracting points to an account of each of said more than one player according to said comparing;
repeating said accepting, said comparing and said awarding for at least two different micro events of said event; and
distributing winning earnings to an account of said more than one player based on a comparison on points accumulated in all accounts of said one or more players.

13. The article of manufacture of claim 12 wherein said points have no direct monetary value.

14. The article of manufacture of claim 12 wherein said winning earnings represent real currency.

15. The article of manufacture of claim 12 wherein a number of said micro events is specified prior to accepting any positions on said micro events.

16. The article of manufacture of claim 12 wherein said position on said micro event comprises an amount of points wagered on said micro event, and wherein said amount of points may be different for each position.

17. The article of manufacture of claim 12 wherein said distributing comprises:
distributing winning earnings to an account of said more than one player based on a comparison on points accumulated in all accounts of said one or more players for more than one event.

18. An electronic system comprising:
one or more processors coupled to a bus;
a memory coupled to the one or more processors, wherein the memory comprises a gaming application;
a position determining system coupled to the bus operable to determine a geolocation of the electronic system;
a graphical user interface coupled to the bus;
wherein the electronic system is configured to:
select an event as a subject of a wager;
accept, from more than one player, a position on a micro event of said event;
compare each of said positions to an outcome of said micro event;
award or subtracting points to an account of each of said more than one player according to said comparing;
repeat said accepting, said comparing and said awarding for at least two different micro events of said event; and
distribute winning earnings to an account of said more than one player based on a comparison of points accumulated in all accounts of said one or more players.

19. The electronic system of claim 18 wherein said points have a direct monetary value.

20. The electronic system of claim 18 wherein said winning earnings represent real currency.

21. The electronic system of claim 18 wherein a number of said micro events is specified prior to accepting any positions on said micro events.

22. The electronic system of claim 18 wherein said position on said micro event comprises an amount of points wagered on said micro event, and wherein said amount of points may be different for each position.

23. The electronic system of claim 18 wherein said awarding comprises:
awarding winning earnings to an account of said more than one player based on a comparison on points accumulated in all accounts of said one or more players for more than one event.

24. A computer-implemented method comprising:
accepting at said computer, from more than one player, a position on a micro event of an event;
comparing each of said positions to an outcome of said micro event; and
distributing winning earnings to an account of said more than one player based on a comparison on points accumulated in all accounts of said one or more players.

25. The computer-implement method of claim 24 wherein said points are awarded to all players based on outcome of more than one micro event.

26. The computer-implemented method of claim 24 wherein said points have no direct monetary value.

27. The computer-implemented method of claim 24 wherein said winning earnings represent real currency.

28. The computer-implemented method of claim 24 wherein input for said accepting is acquired by a different computer system for each of said more than one player.

29. The computer-implemented method of claim 24 wherein at least one of said different computer systems is battery powered.

30. A computer-implemented method comprising:
first placing a first wager, wherein the outcome of said first wager is settled in a virtual currency;
second placing a second wager, wherein the outcome of said second wager is settled in real currency,
wherein said first and said second wagers are independent of one another, and
wherein said first and said second placing occurs within the instance of the same application.

31. The computer-implemented method of claim 20 wherein said second wager is made against the house.

32. The computer-implemented method of claim 20 wherein said first wager is made against at least one other human player.
